(19) United States
(12) Patent Application Publication
(10) Pub. No.: US 2003/0128240 A1
(43) Pub. Date: Jul. 10, 2003

(54) Method, system, and computer program product for a GUI to fingerprint scanner interface

(76) Inventors: Chris J. Martinez, Lake Worth, FL (US); Richard Irving, Palm Beach Gardens, FL (US)

Correspondence Address: STERNE, KESSLER, GOLDSTEIN & FOX PLLC, 1100 NEW YORK AVENUE, N.W., WASHINGTON, DC, 20005, US

(21) Appl. No.: 10/308,153

(22) Filed: Dec. 3, 2002

Related U.S. Application Data
(63) Continuation of application No. 09/425,958, filed on Oct. 25, 1999, now abandoned.
(60) Provisional application No. 60/147,498, filed on Aug. 9, 1999.

(51) Int. Cl. G09G 5/00

(52) U.S. Cl. 345/764; 345/763

(57) ABSTRACT

An interface between a fingerprint scanner and a graphical user interface is described. A software development kit couples the fingerprint scanner with the graphical user interface. A computer system may include the graphical user interface and software development kit. The fingerprint scanner may be a ten-print fingerprint scanner. The software development kit may include an image capture module, an image format module, an image enhancement module, a motor control module, a calibration control module, and a LED/lighting control module.

### CROSS-REFERENCE TO RELATED APPLICATIONS

This application claims the benefit of priority under 35 U.S.C. § 119(e) to appl. Ser. No. 60/147,498, filed Aug. 9, 1999, and incorporated in its entirety herein by reference.

This patent application is potentially related to the following co-pending U.S. utility patent applications:

1. “System and Method for Transferring a Packet with Position Address and Line Scan Data Over an Interface,” Ser. No. (to be assigned), Attorney Docket No. 1823.0110001, by W. Scott et al., filed concurrently herewith and incorporated in its entirety herein by reference;

2. “Adjustable, Rotatable Finger Guide in a Tenprint Scanner with Movable Prism Platen,” Ser. No. (to be assigned), Attorney Docket No. 1823.0130000, by J. Carver et al., filed Oct. 22, 1999, and incorporated in its entirety herein by reference;

3. “Calibration and Correction in a Fingerprint Scanner,” Ser. No. (to be assigned), Attorney Docket No. 1823.0140000, by R. Irving et al., filed concurrently herewith and incorporated its entirety herein by reference; and

4. “Method, System, and Computer Program Product for Control of Platen Movement during a Live Scan,” Ser. No. (to be assigned), Attorney Docket No. 1823.0220000, by G. Barton et al., filed concurrently herewith and incorporated in its entirety herein by reference.

### BACKGROUND OF THE INVENTION

1. Field of the Invention

The present invention is directed to the field of fingerprint imaging systems and, in particular, to interfacing a fingerprint scanner with a graphical user interface.

2. Related Art

Biometrics is a science involving the analysis of biological characteristics. Biometric imaging captures a measurable characteristic of a human being for identity purposes. See, e.g., Gary Roethenbaugh, Biometrics Explained, International Computer Security Association, Inc., pp. 1-34, (1998), which is incorporated herein by reference in its entirety.

Biometric imaging captures a measurable characteristic of a human being for identity purposes. One type of biometric imaging system is an Automatic Fingerprint Identification System (AFIS). Automatic Fingerprint Identification Systems are used for law enforcement purposes. Law enforcement personnel collect fingerprint images from criminal suspects when they are arrested. Law enforcement personnel also collect fingerprint images from crime scenes. These are known as latent prints.

Ten-print scanners are a common type of AFIS system. Ten-print scanners produce forensic-quality ten-print records of rolled and plain impression fingerprint images. Typical ten-print scanners are frequently custom-made consoles. Such custom-made consoles contain built-in equipment, such as a monitor, a keyboard, a pointing device, and at least one processor, for receiving control input from a user, and processing and viewing the fingerprint images. The console and ten-print scanner combination form a complete fingerprint imaging system. The custom-made consoles are expensive. Furthermore, the software or hardware used to interface the console and fingerprint scanner must be customized to the particular setup.

Custom-made consoles are also burdened with high maintenance costs. When the console malfunctions, the entire system is inoperable. Ten-print scanner system owners must then place a service call to the manufacturer to have a technician come on-site and correct the problem. This can sometimes be a lengthy process. During such maintenance periods, ten-print records cannot be produced.

Hence, what is needed is a ten-print scanner system that does not depend on an expensive, built-in console for receiving control input from a user, and processing and viewing fingerprint images. What is further needed is a system and method for interfacing a ten-print scanner system to a personal computer (PC) for receiving control input from a user, and processing and viewing fingerprint images, wherein the ten-print scanner system is not dependent upon any particular personal computer make or model.

Custom-made consoles also suffer from disadvantages of inflexibility. In different operating environments, it may be desirable to modify a user interface such as a GUI (graphical user interface) provided by the console in order to provide the user with functions most advantageous in each particular environment. It may be desirable to remove certain functions from user access in some environments. For instance, in FBI-related fingerprinting operations, it may desirable to only allow viewing of fingerprint images in a format that is FBI compliant. Frequently, a conventional user interface cannot be easily customized to the particular application.

Hence, what is also needed is a system and method for interfacing a ten-print scanner system to a user interface such as a GUI, wherein the interface between the fingerprint scanner and user interface is easily adaptable to various operating environments, without requiring costly hardware or software modifications.

Conventional consoles with user interfaces such as a GUI also suffer from a lack of functionality. Frequently a user interface does not provide a user with sufficient control access to fingerprint scanner functions. What is also needed is a console with a user interface that allows a user to input a wide variety of control and status requests related to the fingerprint scanner, and correspondingly provides a wide variety of useful output indicators.

### SUMMARY OF THE INVENTION

The present invention is directed to an interface between a fingerprint scanner and a graphical user interface. A software development kit interfaces the fingerprint scanner with the graphical user interface. A computer system may include the graphical user interface and software development kit. The fingerprint scanner may be a ten-print fingerprint scanner. The software development kit may include an image capture module, an image format module, an image enhancement module, a motor control module, a calibration control module, and a LED/lighting control module.

Interfacing a graphical user interface with a fingerprint scanner using a software development kit according to the present invention provides advantages. The software development kit of the present invention provides a flexible interface for easy and inexpensive customization of a fingerprint imaging system to a particular environment or application. The software development kit allows the user interface to provide the user with a large number of useful control and status functions. The software development kit also allows the user interface to be easily customized.

The present invention has the advantage of interfacing a fingerprint scanner with an off-the-shelf personal computer. Furthermore, the present invention has the advantage of interfacing a fingerprint scanner with applications that run on off-the-shelf personal computers.

Further embodiments, features, and advantages of the present inventions, as well as the structure and operation of the various embodiments of the present invention, are described in detail below with reference to the accompanying drawings.

### BRIEF DESCRIPTION OF THE FIGURES

The accompanying drawings, which are incorporated herein and form a part of the specification, illustrate the present invention and, together with the description, further serve to explain the principles of the invention and to enable a person skilled in the pertinent art to make and use the invention.

In the drawings:

FIG. 1A shows an example embodiment of a software development kit interface between a GUI and fingerprint scanner of the present invention;

FIG. 1B shows a block diagram illustrating an embodiment of the software development kit of the present invention;

FIG. 1C shows a exemplary block diagram illustrating a computer system coupled to a fingerprint scanner according to an embodiment of the present invention;

FIGS. 2A and 2B show flowcharts providing detailed operational steps of an example embodiment of the present invention;

FIG. 3 shows an example graphical user interface configuration according to an embodiment of the present invention;

FIG. 4 shows an example booking station environment of the present invention;

FIGS. 5A and 5B respectively show the front and back of a FBI fingerprint card;

FIG. 6 shows an example digital fingerprint live scanner according to an embodiment of the present invention;

FIG. 7 shows an example finger guide for a fingerprint scanner;

FIG. 8 shows example connections for interfacing with a fingerprint scanner according to an embodiment of the present invention;

FIG. 9A shows an example of a fingerprint scanner according to an embodiment of the present invention;

FIG. 9B shows an example of a fingerprint imaging system according to an embodiment of the present invention;

FIG. 10 shows a perspective view of an example fingerprint scanner according to an embodiment of the present invention;

FIG. 11 shows a computer system interfaced with a fingerprint scanner in an example set up according to an embodiment of the present invention; and

FIG. 12 shows an example computer system for implementing the present invention.

The present invention will now be described with reference to the accompanying drawings. In the drawings, like reference numbers indicate identical or functionally similar elements. Additionally, the left-most digit(s) of a reference number identifies the drawing in which the reference number first appears.

### DETAILED DESCRIPTION OF THE PREFERRED EMBODIMENTS

### Table of Contents

Overview and Terminology

Example Software Development Kit Interface

Software Development Kit

Set or Control Requests

Get or Status Requests

Image capture module

Brightness

Contrast

Live Mode

Image Format Module

Image Format

Integration Time

Crop Mode

Zoom Factor

Zoom Left, Zoom Top

Image Enhancement Module

Correction Mode

Line

Motor Control Module

Motor Position

Limit Speed Property

Motor Status

Motor Mode

Calibration Control Module

LED/Lighting Control Module

Additional Modules

Device Properties

Reset

Save Image

Load Image

Save Raw Image

Clear Image

Position Histogram

Enable Protected

Example GUI Panel

Example Booking Station Environment

Example Fingerprint Scanner

Fingerprint Scanner Highlights

Fingerprint Scanner Overview

Key Features

Case

Image Capture Area (Platen)

Image Quality

Cables, Connections and Throughput

Power

FIREWIRE

USB

Software Drivers

Software Development Kit

Installation

Training

Maintenance

Support

Sharing Data

Image Compression and Storage

Using WSQ Compression

Interfacing Using EFTS

Store and Forward

AFIS Connectivity

FBI/IAFIS Connectivity

Compatibility with the Mobile Hand-held Scanner Images

Summary

Features and Benefits

Mechanical Specifications

Computer System

Example GUI Computer Environment

Conclusion

Overview and Terminology

The present invention is directed to an interface between a fingerprint scanner and a graphical user interface. In a preferred embodiment, the present invention is a software development kit. In a preferred embodiment, the software development kit is coupled between the fingerprint scanner and the graphical user interface, which is displayed by a computer. The computer can be any commercially available computer, including a personal computer.

The software development kit handles real-time and interactive fingerprint scanner control events requested through the graphical user interface. The software development kit also handles real-time and interactive status requests from the graphical user interface to the fingerprint scanner.

The present invention has the advantage of integrating a fingerprint scanner into applications that run on off-the-shelf personal computers. In a preferred embodiment, the software development kit operates in an ActiveX environment allowing the integration of a variety of off-the-shelf software applications. These applications may include Microsoft Visual C++ and Microsoft Visual BASIC, among others.

The software development kit provides a wide variety of control and status functions related to the fingerprint scanner which may be accessed through the user interface, which may be a GUI. The software development kit allows for a user and/or a system administrator to determine which of the available functions are to be made accessible to users. Through the system development kit, the system administrator may make some functions unavailable to users, if desired. The system administrator may require that a password be entered before access to some functions is granted, if desired.

In embodiments, the user interface is a graphical user interface. The graphical user interface is customizable. In a preferred embodiment, the software development kit and graphical user interface operate in the same local computer system.

To more clearly delineate the present invention, an effort is made throughout the specification to adhere to the following term definitions as consistently as possible.

The term “finger” refers to any digit on a hand including, but not limited to, a thumb, an index finger, middle finger, ring finger, or a pinky finger.

The term “live scan” refers to a scan of any type of fingerprint image by a fingerprint scanner. A live scan can include, but is not limited to, a scan of a finger, a finger roll, a flat finger, slap print of four fingers, thumb print or palm print.

The term “fingerprint scanner” is any type of scanner which can obtain an image of all or part of one or more fingers in a live scan including, but not limited to, a tenprint scanner. A “tenprint scanner” is a scanner that can capture images representative of ten fingers of a person. The captured images can be combined in any format including, but not limited to, an FBI tenprint format.

The term “platen” refers to a component that include an imaging surface upon which at least one finger is placed during a live scan. A platen can include, but is not limited to, an optical prism, set of prisms, or set of micro-prisms.

The term “latent fingerprint” means a fingerprint captured directly from a surface, not from a live subject.

The term AFIS is an acronym for Automated Fingerprint Identification System.

The term ANSI is an acronym for American National Standards Institute.

The term EFTS is an acronym for Electronic Fingerprint Transaction Specification.

The term IAFIS is an acronym for International Automated Fingerprint Identification System.

The term NIST is an acronym for National Institute of Standards and Technology.

The term PCI is an acronym for Peripheral Component Interconnect, a local bus standard for personal computers developed by Intel Corporation.

The term VAR is an acronym for Value Added Reseller.

Example Software Development Kit Interface

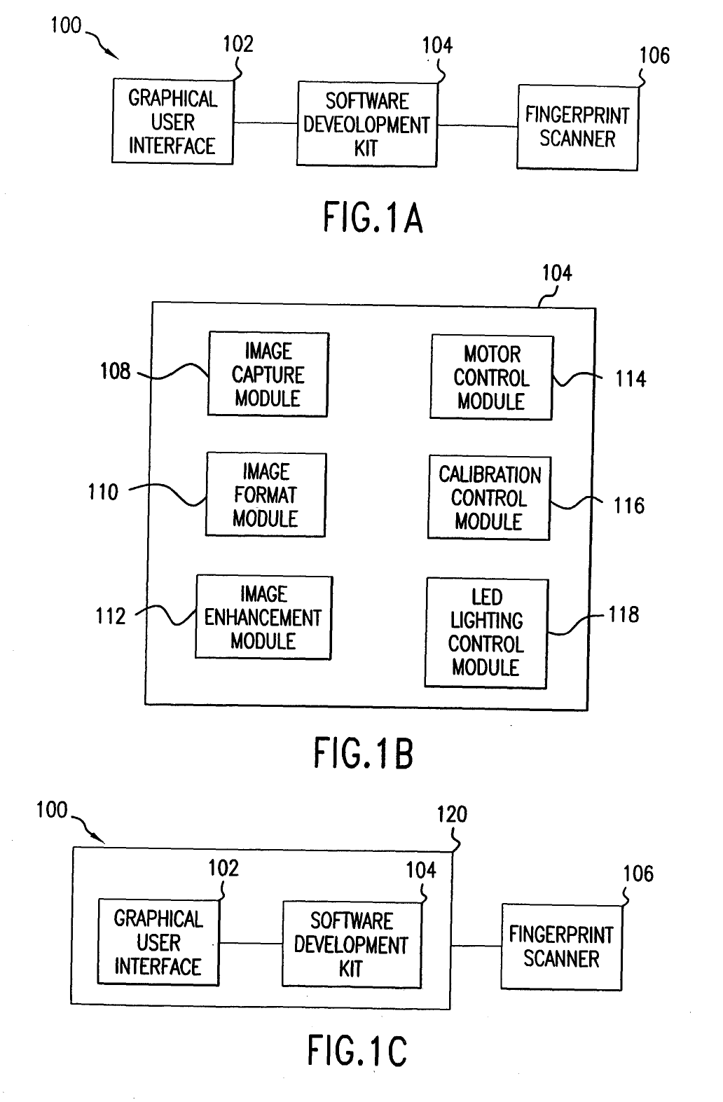

FIG. 1A illustrates a fingerprint imaging system 100 according to an embodiment of the present invention. Fingerprint imaging system 100 includes a graphical user interface 102, a software development kit 104, and a fingerprint scanner 106. Software development kit 104 interfaces graphical user interface 102 with fingerprint scanner 106.

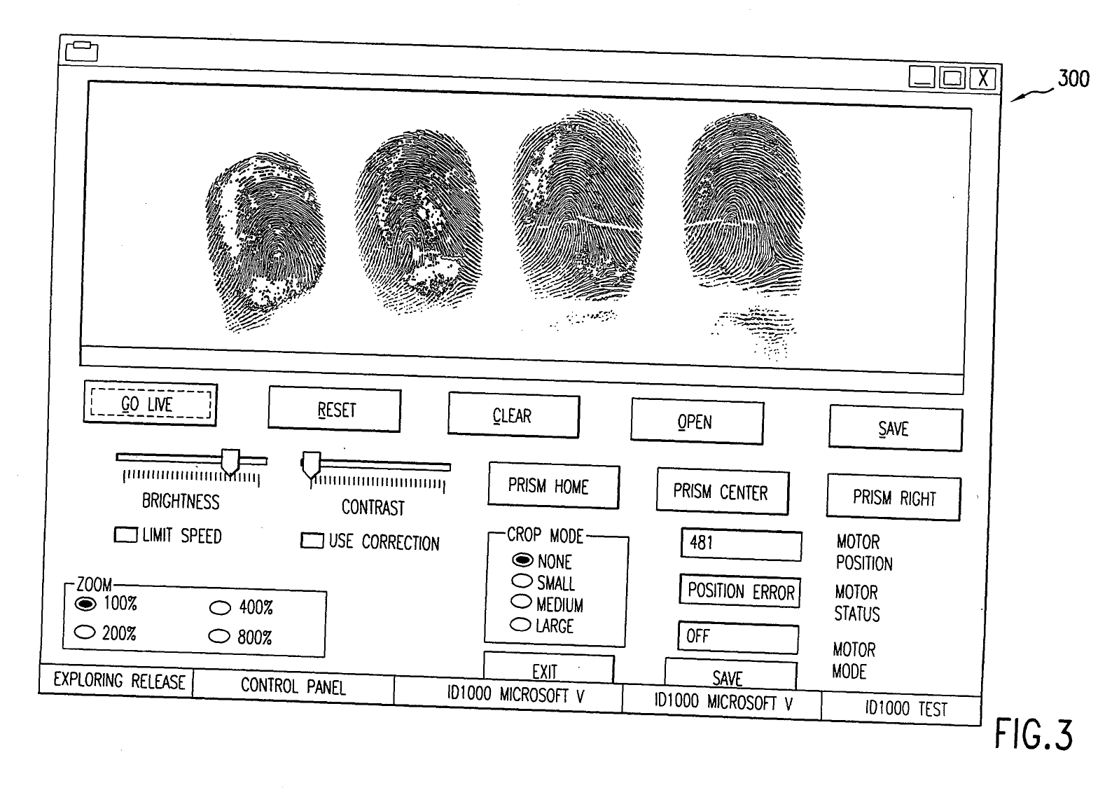

Graphical user interface 102 displays information related to the output of fingerprint scanner 106. Graphical user interface 102 allows a user to request status and other information from fingerprint scanner 106, and to supply control instructions to fingerprint scanner 106, through software development kit 104. FIG. 3 shows an example graphical user interface configuration according to an embodiment of the present invention.

Software development kit 104 receives input signals from graphical user interface 102. These input signals include requests for status information from fingerprint scanner 106, and control instructions for fingerprint scanner 106. Software development kit 104 determines whether a request is a status request or a control request. Software development kit 104 formats and transmits the status requests and control instructions to fingerprint scanner 106. Software development kit 104 receives fingerprint image data and related information, and status information from fingerprint scanner 106. Software development kit 104 transmits the received fingerprint image data and related information, and status information to graphical user interface 102.

Fingerprint scanner 106 captures one or more of a user's fingerprints. Fingerprint scanner 106 may be any suitable type of fingerprint scanner, known to persons skilled in the relevant art(s). Fingerprint scanner 106 includes a fingerprint image capturing area or surface for capturing fingerprints. Fingerprint scanner 106 is coupled to software development kit 104. Fingerprint scanner 106 outputs fingerprint image data and related information, and inputs control information and status requests from software development kit 104.

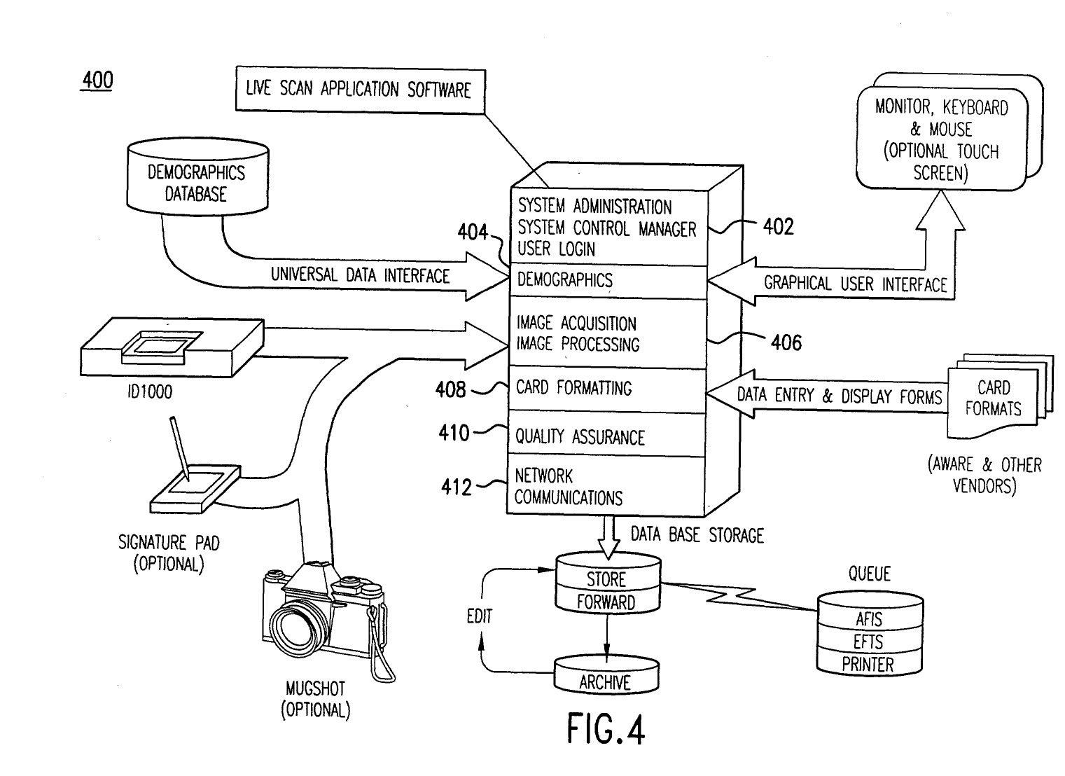

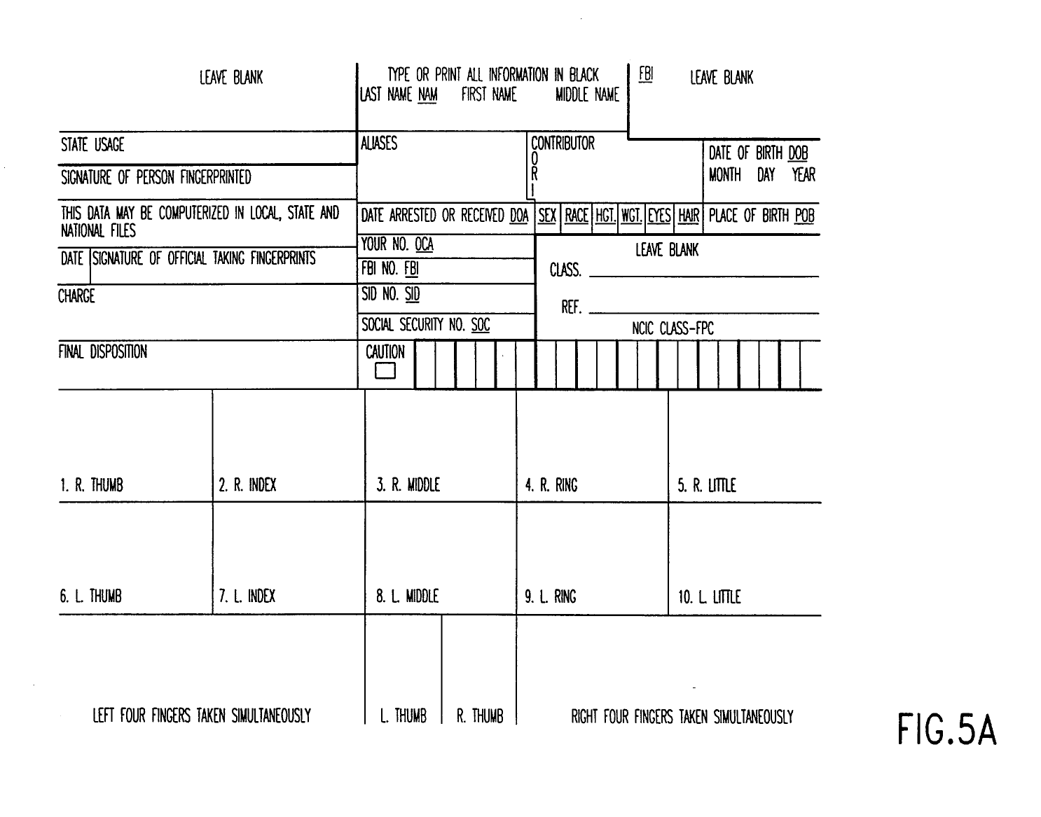

The present invention is described in terms of this example environment. However, the present invention can be used in any environment where a software development kit interfaces a graphical user interface with a fingerprint scanner. For example, an embodiment of the present invention is described below in relation to a booking station environment shown in FIG. 4.

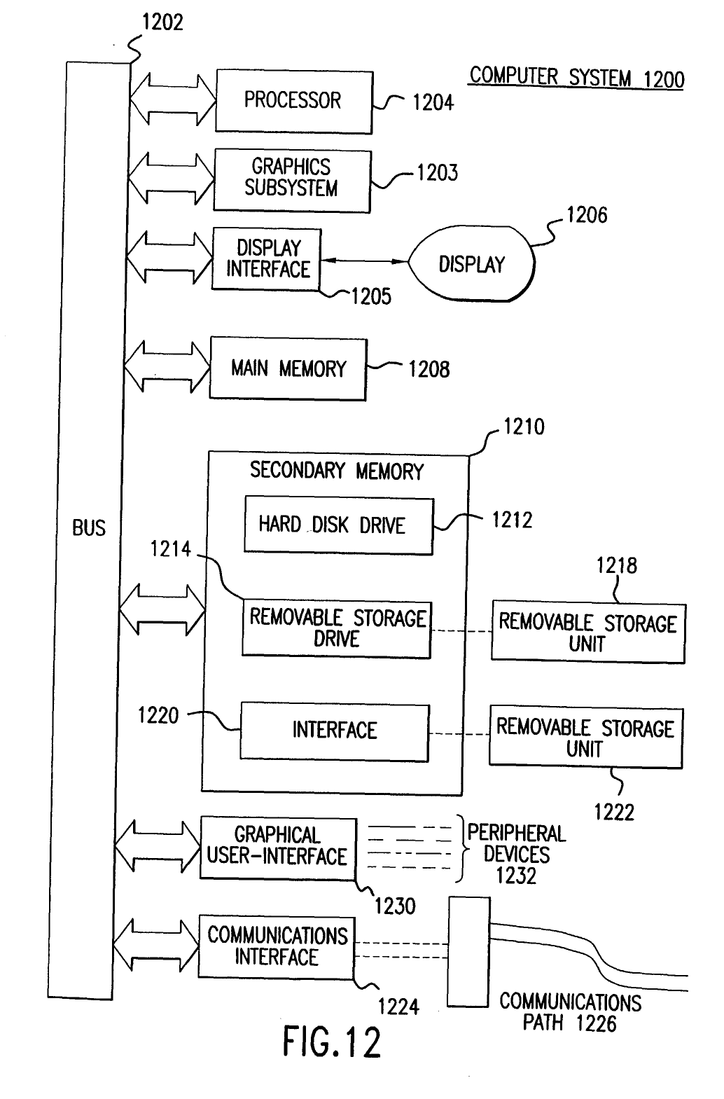

FIG. 12 illustrates an embodiment of the present invention implemented in a computer. In embodiments, a computer system 1200 may comprise one or both of graphical user interface 102 and software development kit 104. FIG. 1C shows a preferred embodiment of the present invention, where a computer system 120 comprises graphical user interface 102 and system development kit 104. The present invention is not limited to these implementations. The present invention as described in this section can be achieved using any number of structural implementations, including hardware, firmware, software, or any combination thereof. The details of such structural implementations will be apparent to persons skilled in the relevant art(s) based on the teachings contained herein.

Description in these terms is provided for convenience only. It is not intended that the invention be limited to application in this example environment. In fact, after reading the following description, it will become apparent to a person skilled in the relevant art how to implement the invention in alternative environments known now or developed in the future.

Software Development Kit

Structural implementations for a software development kit are described at a high-level, and at a more detailed level. These structural implementations are described herein for illustrative purposes, and are not limiting. In particular, the software development kit described in this section can be achieved using any number of structural implementations, including hardware, firmware, software, or any combination thereof. The details of such structural implementations will be apparent to persons skilled in the relevant art(s) based on the teachings contained herein.

FIG. 1B shows an exemplary software development kit 104, according to an embodiment of the present invention. Software development kit 104 of FIG. 1B comprises an image capture module 108, an image format module 110, an image enhancement module 112, a motor control module 114, a calibration control module 116, and a LED/lighting control module 118.

Each module may provide at least one or more of the functions described below. The functions generally fall into two categories: set (control request) and get (status request). A set, or control, request generally is accompanied by a function parameter and a value parameter. The function parameter determines what module function is being affected. The value parameter determines the particular setting for the corresponding function. A get, or status, request generally is accompanied by a function parameter, which determines from what module function status is being requested.

The “set” and “get” requests may be requested in graphical user interface 102 in a number of ways, including through use of a mouse, a roller ball, a stylus, a touch screen, voice control input, and keyboard entry. Voice control input is a feature of the invention, for example, in environments such as law enforcement where an officer cannot use one or both of his or her hands at a GUI. Other methods for inputting requests will be known to persons skilled in the relevant art(s).

Requests may be made by users, including users designated as system administrators. System administrators may have greater access rights to the system than other users. The system administrator may find it desirable to prevent certain users from access to some of the system functions. Access to one or more of the functions may be prevented by the system administrator through the use of password protection. Access to virtually all functions, including those described below, may be controlled in this manner.

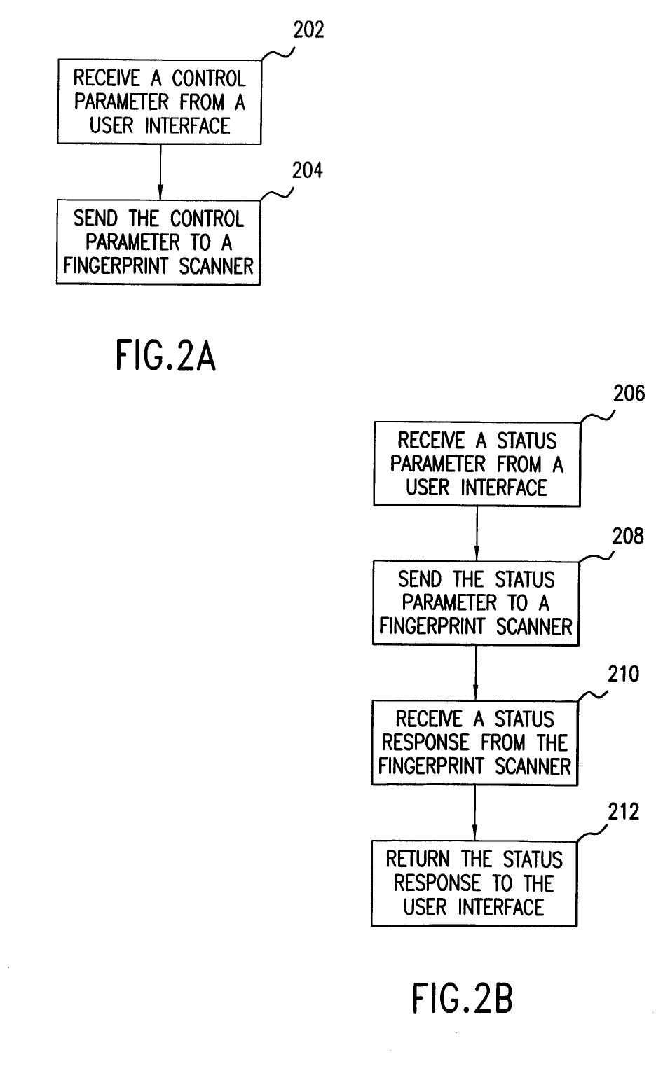

FIGS. 2A and 2B show flowcharts providing detailed operational steps of example embodiments of the present invention. The steps of FIGS. 2A and 2B may be implemented in hardware, firmware, software, or any combination thereof. For instance, the steps of FIGS. 2A and 2B may be implemented by the various modules within software development kit 104. Other structural embodiments will be apparent to persons skilled in the relevant art(s) based on the discussion contained herein. These steps are described in detail below.

Set or Control Requests

FIG. 2A shows exemplary operational steps for a set or control request.

In step 202, a control parameter is received from a user interface. For example, this control parameter may include a “set” or control request, a function parameter, and a value parameter. Control then passes to step 204.

In step 204, the control parameter is sent to a fingerprint scanner. The fingerprint scanner executes the received control parameter.

Get or Status Requests

FIG. 2B shows exemplary operational steps for a get or status request.

In step 206, a status parameter is received from a user interface. For example, this status parameter may include a “get” or status request and a function parameter. Control then passes to step 208.

In step 208, the status parameter is sent to a fingerprint scanner. Control then passes to step 210.

In step 210, a status response is received from the fingerprint scanner. Control then passes to step 212.

In step 212, the status response is returned to the user interface. In an embodiment, graphical user interface 102 may then display the status response.

More detailed structural and operational embodiments for implementing the steps of FIGS. 2A and 2B are described below. Specific exemplary control and status functions for module embodiments of software development kit 104 are provided. These embodiments are provided for purposes of illustration, and are not intended to limit the invention. Alternate embodiments, differing slightly or substantially from those described herein, will be apparent to persons skilled in the relevant art(s) based on the teachings contained herein.

Image Capture Module

Image capture module 108 allows a user to request status relating to image capture by fingerprint scanner 106, and to control various aspects of fingerprint image capture by fingerprint scanner 106. The user inputs their requests through graphical user interface 102. Responses to these requests may be displayed by graphical user interface 102. Exemplary functions related to image capture module 108 are described as follows.

Brightness

Software development kit 104 may receive a “set brightness” request or parameter from graphical user interface 102, and send this request to fingerprint scanner 106. “Set brightness” allows the user to vary the light intensity applied by fingerprint scanner 106 to the subject fingerprint being scanned and imaged. In an embodiment, this request uniformly varies the intensity of all LEDs illuminating the fingerprint imaging region in fingerprint scanner 106. In an alternate embodiment, the brightness of one or more of the LEDs in fingerprint scanner 106 is varied independently of other LEDs. Light sources for fingerprint scanner 106 other than LEDs are also within the scope of the present invention.

Software development kit 104 may receive a “get brightness” request or parameter from graphical user interface 102. This causes software development kit 104 to send a request for the current brightness level from fingerprint scanner 106. The current brightness level is received by software development kit 104 from fingerprint scanner 106. Software development kit 104 returns the received brightness level to graphical user interface 102.

Contrast

Software development kit 104 may receive a “set contrast” request or parameter from graphical user interface 102, and send this request to fingerprint scanner 106. “Set contrast” allows the user to change the contrast of the fingerprint image being displayed by adjusting the camera in fingerprint scanner 106. In an embodiment, this request varies gain registers in the imaging camera of fingerprint scanner 106 uniformly. In an alternate embodiment, the gain registers in the imaging camera of fingerprint scanner 106 may be varied independently of each other.

Software development kit 104 may receive a “get contrast” request or parameter from graphical user interface 102. This causes software development kit 104 to send a request for the current contrast level from fingerprint scanner 106. The current contrast level is received by software development kit 104 from fingerprint scanner 106. Software development kit 104 returns the received contrast level to graphical user interface 102.

Live Mode

Software development kit 104 may receive a “set live mode” request or parameter from graphical user interface 102, and send this request to fingerprint scanner 106. “Set live mode” allows the user to set the fingerprint scanner 106 into a live mode of true or false such that fingerprint images can be captured or not captured, respectively.

Software development kit 104 may receive a “get live mode” request or parameter from graphical user interface 102. This causes software development kit 104 to send a request for the current live mode from fingerprint scanner 106. The current live mode is received by software development kit 104 from fingerprint scanner 106. Software development kit 104 returns the received live mode to graphical user interface 102.

Image Format Module

Image format module 110 allows a user to request status regarding image formatting, and to control various aspects of fingerprint image formatting. The user inputs their requests through graphical user interface 102. Responses to these requests may be displayed by graphical user interface 102. Exemplary functions related to image format module 110 are described as follows.

Image Format

Software development kit 104 may receive a “set image format” request or parameter from graphical user interface 102, and send this request to fingerprint scanner 106. “Set image format” allows the select the format of fingerprint images. In an embodiment, there are three fingerprint image formats: raw (image as captured by fingerprint scanner), fill (image after having passed through a correction algorithm), and decimated (image with half the resolution of a full image). Any format can be used. In embodiments, one or more of these formats conform with the requirements of an agency, such as the FBI or other federal agency, or a state or local government agency. Formats for a private security agency, commercial business, or other organization can also be used. Further image formats are also within the scope of the present invention. In an embodiment, use of this “set image format” request is password protected, as it may be desirable to allow or disallow end users from having this capability to select a raw image format or other format.

Software development kit 104 may receive a “get image format” request or parameter from graphical user interface 102. This causes software development kit 104 to send a request for the current image format from fingerprint scanner 106. The current image format is received by software development kit 104 from fingerprint scanner 106. Software development kit 104 returns the received image format to graphical user interface 102.

Integration Time

Software development kit 104 may receive a “set integration time” request or parameter from graphical user interface 102, and send this request to fingerprint scanner 106. “Set integration time” allows the user to vary the amount of time which the imaging camera of fingerprint scanner 106 has to integrate the image being captured.

Software development kit 104 may receive a “get integration time” request or parameter from graphical user interface 102. This causes software development kit 104 to send a request for the current integration time from fingerprint scanner 106. The current integration time is received by software development kit 104 from fingerprint scanner 106. Software development kit 104 returns the received integration time value to graphical user interface 102.

Crop Mode

Software development kit 104 may receive a “set crop mode” request or parameter from graphical user interface 102, and send this request to fingerprint scanner 106. “Set crop mode” allows the user to vary the size of fingerprint image cropping. In an embodiment, there are four crop modes: no cropping (capture full screen), crop a four-fingerprint image, crop a rolled fingerprint, and crop an individual fingerprint. In embodiments, these various crop window sizes are defined by an agency, such as the FBI. In alternate embodiments, the crop window can be varied to any size. In embodiments, the crop window can be “dragged and dropped” over an area of interest.

Software development kit 104 may receive a “get crop mode” request or parameter from graphical user interface 102. This causes software development kit 104 to send a request for the current crop mode from fingerprint scanner 106. The current crop mode is received by software development kit 104 from fingerprint scanner 106. Software development kit 104 returns the received crop mode to graphical user interface 102.

Zoom Factor

Software development kit 104 may receive a “set zoom factor” request or parameter from graphical user interface 102, and send this request to fingerprint scanner 106. “Set zoom factor” allows the user to vary the degree of zoom to which fingerprint image is subject. In an embodiment, there are four zoom factors: 100%, 200%, 400%, and 800%. In alternate embodiments, the zoom factor can be varied to any degree.

Software development kit 104 may receive a “get zoom factor” request or parameter from graphical user interface 102. This causes software development kit 104 to send a request for the current zoom factor from fingerprint scanner 106. The current zoom factor is received by software development kit 104 from fingerprint scanner 106. Software development kit 104 returns the received zoom factor to graphical user interface 102.

Zoom Left, Zoom Top

Software development kit 104 may receive a “set zoom left, zoom top” request or parameter from graphical user interface 102, and send this request to fingerprint scanner 106. “Set zoom left, zoom top” allows the user to vary the point around which the image is zoomed upon. In an embodiment, zoom left, zoom top are “x” and “y” coordinates in a fingerprint image. In an embodiment, these coordinates can be set by a mouse button click. In alternate embodiments, coordinates can be entered by keyboard, voice control input, or by other computer peripheral devices.

Software development kit 104 may receive a “get zoom left, zoom top” request or parameter from graphical user interface 102. This causes software development kit 104 to send a request for the current zoom left, zoom top values from fingerprint scanner 106. The current zoom left, zoom top values are received by software development kit 104 from fingerprint scanner 106. Software development kit 104 returns the received zoom left, zoom top values to graphical user interface 102.

Image Enhancement Module

Image enhancement module 112 allows a user to request status regarding image enhancement, and to control various aspects of fingerprint image enhancement. The user inputs their requests through graphical user interface 102. Responses to these requests may be displayed by graphical user interface 102. Exemplary functions related to image embodiment module 112 are described as follows.

Correction Mode

Software development kit 104 may receive a “set correction mode” request or parameter from graphical user interface 102, and send this request to fingerprint scanner 106. “Set correction mode” allows the user to turn on or off the ability to correct images. In an embodiment, use of this request is password protected, as it may be desirable to allow or disallow end users from having this capability.

Software development kit 104 may receive a “get correction mode” request or parameter from graphical user interface 102. This causes software development kit 104 to send a request for the current correction mode from fingerprint scanner 106. The current correction mode is received by software development kit 104 from fingerprint scanner 106. Software development kit 104 returns the received correction mode to graphical user interface 102.

Line

Software development kit 104 may receive a “set line” request or parameter from graphical user interface 102, and send this request to fingerprint scanner 106. “Set line” allows the user to select a horizontal or vertical scan line at a particular position of a captured fingerprint image. In embodiments, the request may be more specific, such as “set full line” or “set decimated line”, depending on the particular line format desired.

Software development kit 104 may receive a “get line” request or parameter from graphical user interface 102. This allows a user to view a particular scan line captured by the fingerprint scanner. This causes software development kit 104 to send a request for the current “set” line from fingerprint scanner 106. The current “set” line is received by software development kit 104 from fingerprint scanner 106. Software development kit 104 returns the received “set” line to graphical user interface 102. In embodiments, the request may be more specific, such as “get full line” or “get decimated line”, depending on the particular line format desired.

Motor Control Module

Motor control module 114 allows a user to request status regarding motor control in fingerprint scanner 106, and to control various aspects of motor operation in fingerprint scanner 106. For instance, functions relating to the motor that controls the movement of the fingerprint imaging prism in fingerprint scanner 106 can be defined. The user inputs their requests through graphical user interface 102. Responses to these requests may be displayed by graphical user interface 102. Exemplary functions related to motor control module 114 are described as follows.

Motor Position

Software development kit 104 may receive a “set motor position” request or parameter from graphical user interface 102, and send this request to fingerprint scanner 106. “Set motor position” allows the user to adjust the motor that moves the fingerprint imaging prism, moving the prism to a particular location. In embodiments, one or more locations can be previously defined relative to the prism, such as “right”, “left”, “center”, and/or “calibration location”. In further embodiments any location on the prism can be designated.

Software development kit 104 may receive a “get motor position” request or parameter from graphical user interface 102. This causes software development kit 104 to send a request for the current motor position from fingerprint scanner 106. The current motor position is received by software development kit 104 from fingerprint scanner 106. Software development kit 104 returns the received motor position to graphical user interface 102.

Limit Speed Property

Software development kit 104 may receive a “set limit speed” request or parameter from graphical user interface 102, and send this request to fingerprint scanner 106. “Set limit speed” allows the user to toggle on or off control of movement of the prism. For instance, in embodiments, when “set limit speed” is on, if the user tries to move the prism too fast, a motion control system will resist movement of the prism. When “set limit speed” is off, the user can move the prism as fast as they desire. See, the example control described in “Method, System, and Computer Program Product for Control of Platen Movement during a Live Scan,” Ser. No. (to be assigned), Attorney Docket No. 1823.0220000, by G. Barton et al., filed concurrently herewith and incorporated in its entirety herein by reference.

Software development kit 104 may receive a “get limit speed” request or parameter from graphical user interface 102. This causes software development kit 104 to send a request for the current limit speed mode from fingerprint scanner 106. The current limit speed mode is received by software development kit 104 from fingerprint scanner 106. Software development kit 104 returns the received limit speed mode to graphical user interface 102.

Motor Status

Software development kit 104 may receive a “set motor status” request or parameter from graphical user interface 102, and send this request to fingerprint scanner 106. “Set motor status” allows the user to set whether or not the motor is ready to operate.

Software development kit 104 may receive a “get motor status” request or parameter from graphical user interface 102. This causes software development kit 104 to send a request for the current motor status from fingerprint scanner 106. The motor status is received by software development kit 104 from fingerprint scanner 106. Software development kit 104 returns the received motor status to graphical user interface 102.

Motor Mode

Software development kit 104 may receive a “set motor mode” request or parameter from graphical user interface 102, and send this request to fingerprint scanner 106. “Set motor mode” allows the user to set the motor into a particular mode of operation. In embodiments, these modes can include: velocity control mode, dither mode, moving mode, holding position mode, and turned off mode. Velocity control mode allows for the speed of the motor to be controlled. Dither mode causes the motor to move the prism back and forth, which may be useful during calibration, for example. Moving mode causes the motor to move the prism to a particular location, and then stops motor movement. Holding position mode causes the motor to be locked into its current position, such that a user cannot move the prism. Turned off mode cause the motor to shut down. Embodiments may include any combination of one or more of these modes.

Software development kit 104 may receive a “get motor mode” request or parameter from graphical user interface 102. This causes software development kit 104 to send a request for the current motor mode from fingerprint scanner 106. The current motor mode is received by software development kit 104 from fingerprint scanner 106. Software development kit 104 returns the received motor mode to graphical user interface 102.

Calibration Control Module

Calibration control module 116 allows a user to control various aspects of the calibration of fingerprint scanner 106. In an embodiment, a user can request that fingerprint scanner 106 run through its calibration routine at any time. Furthermore, the user can set up a system where calibration occurs automatically at periodic intervals, such as at power up. In an embodiment, the system maintains a log file tracking calibration events.

The user inputs their requests through graphical user interface 102. Responses to these requests may be displayed by graphical user interface 102.

LED/Lighting Control Module

LED/lighting control module 118 allows a user to control the illumination of LEDs or other lighting devices in fingerprint scanner 106. This may include varying the intensity of LEDs, or other lighting devices, separately from each other, or uniformly. This may be desirable to optimally illuminate the subject finger for optimal fingerprint imaging. LED/lighting control module 118 may have similar or overlapping functionality with image capture module 108 and/or image format module 110.

The user inputs their requests through graphical user interface 102. Responses to these requests may be displayed by graphical user interface 102.

Additional Modules

Software development kit 104 may comprise modules additional to those described above, and shown in FIG. 1B. These additional modules, and/or the modules already described above, may include some or all of the additional functions described as follows.

Device Properties

Software development kit 104 may receive a “set device properties” request or parameter from graphical user interface 102, and send this request to fingerprint scanner 106. “Set device properties” allows the system administrator to set whether or not users have access to one or more of the control functions described herein, or whether the functions remain hidden to the user. This may be advantageous in situations where certain function settings are required to conform to agency standards, and therefore should not be changed, and in other situations.

Software development kit 104 may receive a “get device properties” request or parameter from graphical user interface 102. This causes software development kit 104 to send a request for the current device properties setting from fingerprint scanner 106. The device properties setting is received by software development kit 104 from fingerprint scanner 106. Software development kit 104 returns the received device properties setting to graphical user interface 102.

Reset

Software development kit 104 may receive a “reset” request or parameter from graphical user interface 102, and send this request to fingerprint scanner 106. “Reset” allows the user to reset the fingerprint imaging system 100 back to its initial state.

Save Image

Software development kit 104 may receive a “save image” request or parameter from graphical user interface 102, and send this request to fingerprint scanner 106. “Save image” allows the user to save a captured fingerprint image to a storage device, preferably located in the local computer system. In alternate embodiments, images can be saved across a network connection, or to other locations. In an embodiment, “save image” causes a full image to be saved by default. In other embodiments, all image formats may be saved.

Load Image

Software development kit 104 may receive a “load image” request or parameter from graphical user interface 102, and send this request to fingerprint scanner 106. “Load image” allows the user to load a previously captured fingerprint image from a storage device, preferably located in the local computer system. In alternate embodiments, images can be loaded from across a network connection, or other locations.

Save Raw Image

Software development kit 104 may receive a “save raw image” request or parameter from graphical user interface 102, and send this request to fingerprint scanner 106. “Save raw image” allows the user to save a captured raw fingerprint image to a storage device, preferably located in the local computer system. In alternate embodiments, raw images can be saved across a network connection, or to other locations. In embodiments, it may be desirable to password protect certain users from using this option, as raw images may not be compliant with certain agency standards.

Clear Image

Software development kit 104 may receive a “clear image” request or parameter from graphical user interface 102, and send this request to fingerprint scanner 106. “Clear image” preferably allows the user to clear captured fingerprint images from fingerprint imaging system 100, without affecting the system settings.

Position Histogram

Software development kit 104 may receive a “set position histogram” request or parameter from graphical user interface 102, and send this request to fingerprint scanner 106. “Set position histogram” allows the user to set the pixel/scan line location(s) for which a histogram may be generated. The histogram shows how many times the location(s) are updated. This may provide the ability to see whether the fingerprint scanner 106 is operating properly. In an embodiment, under proper operation, the generated histogram should be substantially flat.

Software development kit 104 may receive a “get position histogram” request or parameter from graphical user interface 102. This causes software development kit 104 to send a request for the current position histogram from fingerprint scanner 106. The current position histogram is received by software development kit 104 from fingerprint scanner 106. Software development kit 104 returns the received position histogram to graphical user interface 102.

Enable Protected

Software development kit 104 may receive an “enable protected” request or parameter from graphical user interface 102, and send this request to fingerprint scanner 106. “Enable protected” allows the system administrator to enable or disable password protection to all password protected functions described herein.

Software development kit 104 may receive a “get enable protected” request or parameter from graphical user interface 102. This causes software development kit 104 to send a request for the current enable protected mode from fingerprint scanner 106. The enable protected mode value is received by software development kit 104 from fingerprint scanner 106. Software development kit 104 returns the received enable protected mode value to graphical user interface 102.

Example GUI Panel

FIG. 3 shows an example GUI panel 300 that is displayed at graphical user interface 102 according to one example of the present invention. This is not intended to limit the present invention. Other GUI panels can be used as would be apparent to persons skilled in the relevant art(s) given this description.

Example Booking Station Environment

FIG. 4 illustrates an example booking station environment 400 incorporating an interface according to an embodiment of the present invention. Example booking station environment 400 comprises six steps: system administration step 402, demographics step 404, image acquisition/image processing step 406, card formatting step 408, quality assurance step 410, and network communications step 412.

System administration step 402 allows for one or more persons to administer the booking station, to check and maintain proper operation of the fingerprint scanner, and to calibrate the fingerprint scanner, among other administrative tasks known to persons skilled in the relevant art(s). The administrator(s) may maintain a login account, and assign login privileges and access rights to other users.

Demographics step 404 comprises obtaining and/or entering various demographics data relevant to the current fingerprinting capturing operation. This demographics data may include the name of the person being fingerprinted, their address, phone number, where the fingerprints were captured if they are latent fingerprints, and/or the reasons why the subject is being fingerprinted, among other demographics data known to persons skilled in the relevant art(s). This demographics data may be entered by keyboard, or received over a network connection. The demographics data is preferably stored in ANSI/NIST format.

Image acquisition/image processing step 406 comprises the functions executed by the software development kit of the present invention, as described above. This may include receiving images from a fingerprint scanner, a signature pad, and/or a mugshot camera, and from other image capturing devices known to persons skilled in the relevant art(s).

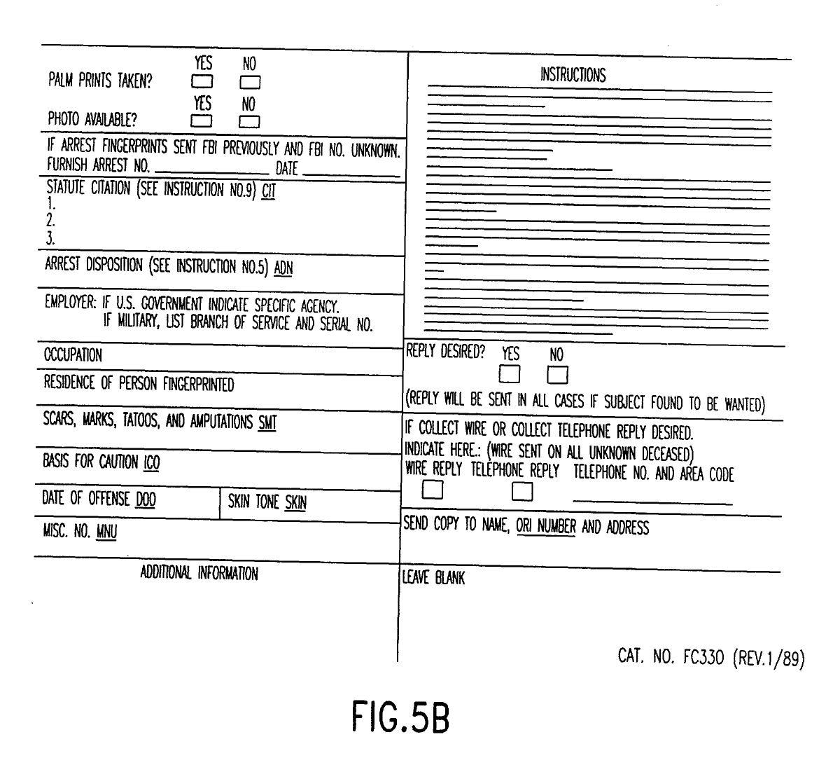

Card formatting step 408 comprises the step of formatting and/or packaging the captured fingerprint image, and demographics data when present, in the proper format for printing, storage, and/or transmission over a network connection. For instance, different agencies such as the FBI and CIA require specific fingerprint image formats. FIGS. 5A and 5B respectively show the front and back of an FBI fingerprint image card, for which the image and demographics data must be formatted in an embodiment. Such formats are known by persons skilled in the relevant art(s). Commercially available software packages, such as NISTPack by Aware, Inc., may handle the formatting and compression of ANSI/NIST and FBI compliant fingerprint images. The present invention is adaptable to these and any other fingerprint image formats.

Quality assurance step 410 comprises the operations necessary for ensuring the continued quality of the system. This includes periodic calibration, monitoring the quality of images, creating service and event logs, and/or other quality assurance related operations known to persons skilled in the relevant art(s).

Network communications step 412 comprises the operations necessary for transmitting the captured fingerprint images to one or more desired destinations. This destinations include various agencies, which may use different computers/networks protocols, so this layer receives the captured and packaged image data, and transmits it to the computers that will do the identification.

The booking station environment described above is provided for purposes of illustration. These embodiments are not intended to limit the invention. Alternate embodiments, differing slightly or substantially from those described herein, will be apparent to persons skilled in the relevant art(s) based on the teachings contained herein.

Example Fingerprint Scanner

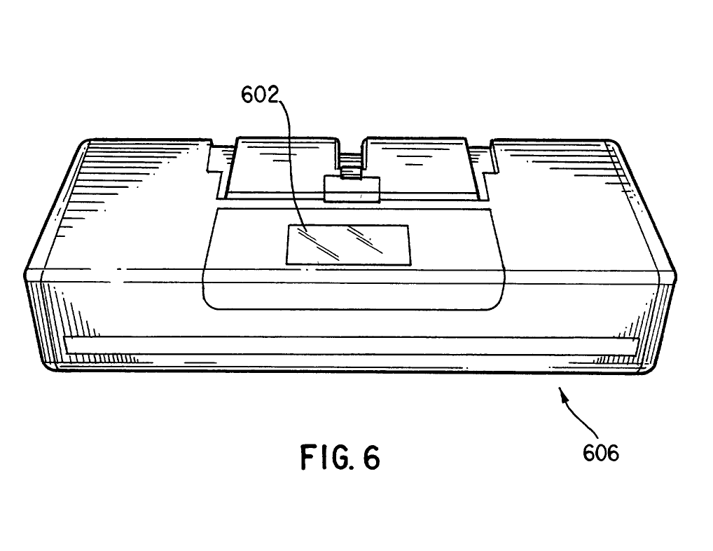

In an example embodiment of a fingerprint scanner 606 shown in FIG. 6 that can use the present invention is described further below. This description is illustrative and is not intended to limit the present invention. In this example, fingerprint scanner 606 replaces traditional ink-on-paper methods. Fingerprint scanner 606 may connect to a standard PC running WINDOWS NT or WINDOWS 2000 via a digital communications interface known as IEEE 1394, or FIREWIRE. The fingerprint scanner 606 may be utilized in either a stand-alone or network environment.

Fingerprint scanner 606 consistently produces distinct, high quality images that may be used for identification by Fingerprint Examiners and/or Automated Fingerprint Identification Systems (AFIS). Fingerprint scanner 606 can produce images exceeding 1000 dots per inch, surpassing existing FBI and AFIS requirements for live scan (non-latent) imaging. This can be especially useful for latent searching and later manual latent matching using various methods, including high-resolution video monitors and software tools.

The data acquisition capabilities of fingerprint scanner 606 allows for real-time identification of individuals at time of arrest and release. Ideal for integration into a digital booking environment, such as that described above in reference to FIG. 4, fingerprint scanner 606 greatly enhances existing products and system installations to ensure the project's success.

For civilian applications the system is non-intimidating, uses no ink (therefore cleaner and easier, with fewer supplies) and can perform rapid image quality checks that reduce common ten-print card rejections.

Fingerprint scanner 606 is designed to be a technically superior device that reduces total cost of ownership and physical space requirements, as compared to other live-scan systems. Fingerprint scanner 606 units may be purchased within the same budget as other systems, and can therefore increase booking throughput dramatically. Immediate return on investment can be realized by the time savings that fingerprint scanner 606 provides.

Fingerprint Scanner Highlights

At least some of the highlights and advantages of fingerprint scanner 606 are described as follows:

The image-capture process features a preview capability allowing the live image to be displayed during capture, providing immediate verification of the quality of the fingerprint image.

Numerical quality control feedback included as an option.

Fingerprint scanner 606 provides a single flat lens platen for complete side-to-side and tip-to-crease fingerprint image capture.

Gray-scale resolution up to 1000 dots-per-inch (DPI) provides clear, classifiable fingerprint images.

Individual rolled fingerprint capture and print size of 1.6″ high×1.5″ wide.

Slap capture and print size of 2″ high×3″ wide.

FBI IQS (Image Quality Standard) Appendix F certified.

Fingerprint Scanner Overview

Fingerprint scanner 606, an embodiment of which is shown in FIG. 6, consists of a rugged case construction with a patented optical system with sliding platen 602, digital CMOS tri-linear camera and FIREWIRE chipset. Also included with the unit is a FIREWIRE cable, software development kit and manuals.

Key Features (see also Table 3 Below)

At least some of the key features of fingerprint scanner 606 are described as follows:

Rugged, reliable construction.

Can be configured as semi-portable or as full booking station (combined with options).

Meets or exceeds existing FBI-IQS and proposed IAI standards for Live Scan 10-print devices.

Simple mechanism for capturing simultaneous impressions and rolled images.

Uses state of the art FIREWIRE (IEEE 1394) image interfacing protocols for high speed capture.

Optional high resolution touch screen demographic display.

Variable capture and re-print capabilities including specific or full finger set capture.

12 volt DC power operation.

Case

The durable case design is intended to provide superior protection for the internal electronic and optical components, while maintaining a weight suitable for portable applications. On each end of the case, built-in handles make transporting fingerprint scanner 606 easy.

The all-aluminum case is not easily damaged, and is designed for harsh environments. The case can be mounted to a desk or table.

The design of fingerprint scanner 606 is ideal for applications such as border patrol, immigration, background checks, arrest and release identification, AFIS connectivity, and other applications where high volume image capture is required.

Fingerprint scanner 606 weighs less than 25 lbs and can fit easily into a carrying case, enabling mobile image capture with remote AFIS connectivity solutions.

Rounded corners and edges maintain a safe operating environment for operators and enrollees.

Image Capture Area (Platen)

The unique moving platen makes for easy image capture, reducing the need for constant re-training. The platen area can be used two ways: 1) rolling prints and 2) flat or plain impressions (slaps).

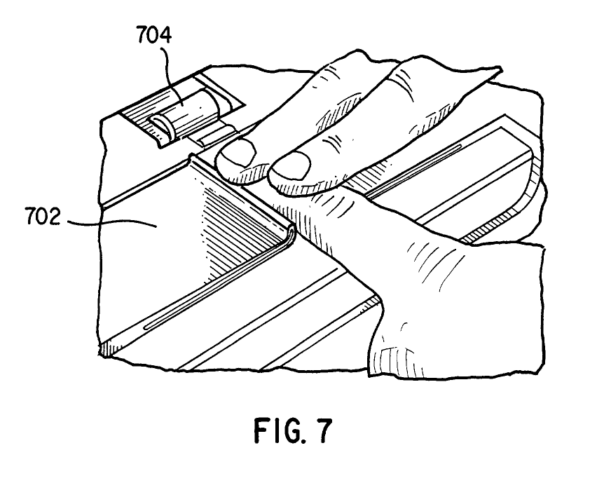

FIG. 7 shows an example of a finger guide 702 in use. With the finger guide 702 rotated into the rolled position, a small area of the platen is visible for rolling fingers. The finger guide has an adjustment 704 to aid in capturing different size fingers. As the finger is rolled, the finger remains in one position while the platen moves underneath. Real time feedback on the computer monitor helps improve rolling accuracy.

With finger guide 702 rotated out of the way, four finger plain impressions and two thumb impressions may be taken quickly. Place the four fingers (or flat thumb) on the platen and slide the platen to the left or right while watching the monitor.

The platen may be cleaned quickly and easily using simple glass cleaner. The non-skid surface aids in capturing wet and dry fingers. The surface is user serviceable.

Image Quality

The optical system of fingerprint scanner 606 allows for imaging resolutions over 1000 dpi. Other imaging resolutions are also within the scope of the present invention. In an embodiment, the base model of fingerprint scanner 606 provides imaging at 500 dpi, making the images compatible with AFIS applications. A software/firmware upgrade will be available which provides imaging resolutions of both 500 dpi and 1000 dpi.

Fingerprint scanner 606 has passed all required tests for the FBI's Image Quality Standard Appendix-F. An overview report is available upon request.

The Software Development Kit for fingerprint scanner 606 may include enhancement tools for zoomed or filtered image viewing, such as described above.

Cables, Connections and Throughput

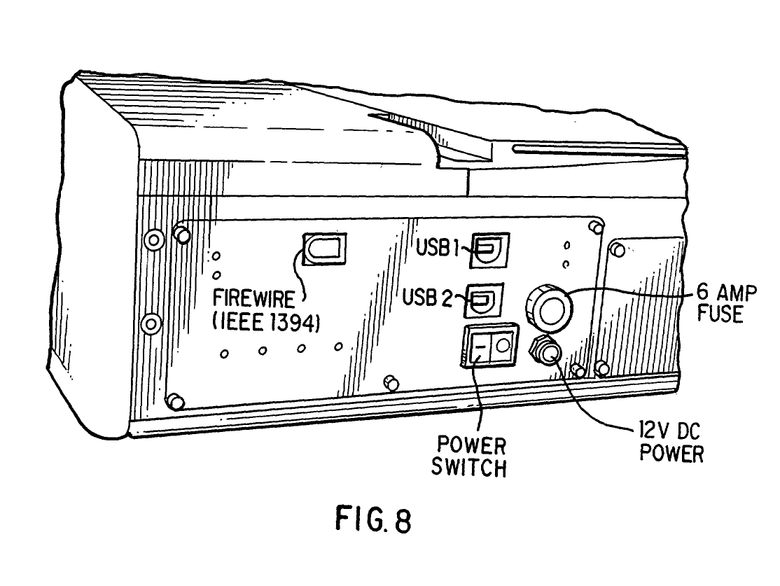

Fingerprint scanner 606 has various simple connections on the rear of the unit, as shown in FIG. 8, and described below.

Power

Fingerprint scanner 606 comes standard with a 95-250 Volt AC to 12 Volt DC switching power supply transformer rated at 6.0 Amps (72 Watts).

An optimal vehicle adapter will be offered for portable use.

Firewire

The FIREWIRE (or IEEE 1394) port is the primary method of communication with the computer for fingerprint scanner 606, as shown in FIG. 8. Video and data communications are transferred simultaneously across this 400 Mbps connection, offering plenty of bandwidth for future enhancements and upgrades to the system (i.e. USB mugshot camera or digital signature pad). Other presently known and future communication methods are also within the scope of the present invention.

Raw image data is transferred real-time from the digital (CMOS) camera via FIREWIRE directly into a computer (equipped with a FIREWIRE PCI adapter or direct interface); there is no need for an analog-to-digital video capture card (or framegrabber).

USB

Two USB (Universal Serial Bus) ports (USB 1 & USB 2) are present on the back of fingerprint scanner 606, as shown in FIG. 8. These ports are for maintenance and troubleshooting purposes. These ports are available for future system upgrades and enhancements.

Software Drivers

The necessary software device drivers needed to install and operate fingerprint scanner 606 are shipped with the unit.

Drivers for Windows NT and Windows 2000 can be used.

Software Development Kit

Additional software (in the form of a Software Development Kit) ships with each fingerprint scanner 606.

This software allows integration of fingerprint scanner 606 into applications using Microsoft Visual C++®, Microsoft Visual Basic®, or any platform that supports ActiveX.

It includes one or more of at least the following components:

Image capture functions

Image formatting functions

Image enhancement functions

Motor control functions

Calibration control functions

LED/Lighting control functions

Installation

Installing fingerprint scanner 606 is straightforward. After setting up the computer and installing a FIREWIRE PCI adapter (if necessary), the device drivers and SDK are installed from the CD provided. Then, simply plug the power adapter transformer into the wall and into fingerprint scanner 606 and turn on the switch. Next, plug in the FIREWIRE cable into fingerprint scanner 606, and into the FIREWIRE adapter in the PC. The operating system will detect the plug-and-play device and register the device drivers with Windows. An auto-configuration utility also runs to set interrupts and memory settings. Now, run the sample application to make sure the device is installed properly. Images can now be captured from fingerprint scanner 606.

Maintenance

Fingerprint scanner 606 is designed to be a cost effective live scanner. To be cost-effective, fingerprint scanner 606 incorporates a low life-cycle maintenance cost. Fingerprint scanner 606 offers years of trouble-free operation. COTS (Commercial Off the Shelf) components help ensure easy part availability and replacement.

Sharing Data

ANSI/NIST and the FBI have developed storage, compression and transmission protocol standards for fingerprints, photos, demographics and other identifying marks.

Typically, the images captured from fingerprint scanner 606 will not only be compressed and stored, but also transmitted to, or shared with other law enforcement entities.

Image Compression and Storage

The example computation in Table 1 below shows the total storage space required for all of the raw images captured by an embodiment of fingerprint scanner 606:

To calculate the size, in KB, of each rolled finger image:

| | |
|---|---|
| 1. | $\begin{matrix} & 750 & pixels ( {1.5}^{″} ) \\ \times & 800 & pixels ( {1.6}^{″} ) \\ & 600 \text{,} 000 & pixels\end{matrix}$ |
| 2. | $\begin{matrix} & 600 \text{,} 000 & pixels \\ \times & 1 & Byte per pixel \\ & 600 \text{,} 000 & Bytes or 600 KB per image\end{matrix}$ |

To calculate the size, in MB, of all 10 finger images:

| | |
|---|---|
| 3. | $\begin{matrix} & 600 & KB \\ \times & 10 & images \\ & 6 & MB\end{matrix}$ |

To calculate the size, in MB, of each four-finger slaps:

| | |
|---|---|
| 4. | $\begin{matrix} & 1000 & pixels ( {2}^{″} ) \\ \times & 1500 & pixels ( {3}^{″} ) \\ & 1 \text{,} 500 \text{,} 000 & pixels\end{matrix}$ |
| 5. | $\begin{matrix} & 1 \text{,} 500 \text{,} 000 & pixels \\ \times & 1 & Byte per pixel \\ & 1 \text{,} 500 \text{,} 000 & Bytes or 1.5 MB per image\end{matrix}$ |

To calculate the size, in MB, of both four-finger slaps:

| | |
|---|---|
| 6. | $\begin{matrix} & 1.5 & MB \\ \times & 2 & images \\ & 3 & MB\end{matrix}$ |

To calculate the size, in KB, of each plain thumb impression:

| | |
|---|---|
| 7. | $\begin{matrix} & 1000 & pixels ( {2}^{″} ) \\ \times & 375 & pixels ( {.75}^{″} ) \\ & 375 \text{,} 000 & pixels\end{matrix}$ |
| 8. | $\begin{matrix} & 375 \text{,} 000 & pixels \\ \times & 1 & Byte per pixel \\ & 375 \text{,} 000 & Bytes or 375 KB per image\end{matrix}$ |

To calculate the size, in MB, of both plain thumb impressions:

| | |
|---|---|
| 9. | $\begin{matrix} & 375 & KB \\ \times & 2 & images \\ & 750 & KB or .75 MB\end{matrix}$ |

TOTAL = 6 MB + 3 MB + .75 MB = 9.75 MB

Using WSQ Compression

In an embodiment, WSQ compression may be used. The only FBI approved method of compressing finger images is by using Wavelet Scalar Quantized (WSQ) algorithms up to a compression ration of 15:1. This can reduce the storage space requirements for all of the images captured by fingerprint scanner 606 to:

$$\frac{\begin{matrix} & 9.75 & MB \\ \div & 15 & \end{matrix}}{ 0.65 MB} ( minus overhead )$$

FBI certified WSQ software is available from several AFIS and third party providers.

Interfacing Using EFTS

After the images are compressed and stored, it is possible to share the data with other entities through the FBI approved Electronic Fingerprint Transmission Standard (EFTS) which is regularly updated by the FBI.

This standard establishes a predetermined format or protocol for all fingerprint data that is to be shared between different AFIS and law enforcement agencies.

FBI certified EFTS software is available from several AFIS and third party providers.

Store and Forward

Store and forward is a method of data management and error recovery used by many customers today.

When fingerprint data is about to be transmitted via a network, especially using public carriers, it is very important to temporarily store the data locally until the transmission of the data is successfully completed. This is especially true if the data is NOT going to be stored on the local machine with fingerprint scanner 606 unit attached.

Several store and forward methodologies exist today, depending on the network topology and protocol that is used (i.e. TCP/IP, IPX, Ethernet, Token Ring, etc.).

Table 2 below shows sample transmission times using EFTS protocols:

TABLE 2

| | DDS/SW56 | | T1 - | | | |
|---|---|---|---|---|---|---|
| | (56 Kbps), | | Quarter | | T1 - Full | |
| COMMUNICATIONS MODE | with Digital | | (384 | | (1.544 | |
| CAPTURE/TRANSMIT RATES | Interface | | Kbps) | | Mbps) | |
| Capture. 500 dpi, | 9.1 | min | 6.6 | min | 1.7 | min |
| Transmit/Print 500 dpi, | | | | | | |
| Gray-scale | | | | | | |
| Capture. 500 dpi, | | | | | | |
| Transmit. WSQ 15.1, | 2 | min. | 53 | sec | 13 | sec. |
| Print 500 dpi, Gray-scale | | | | | | |

AFIS Connectivity

Many established AFIS providers exist today, with many more now entering the market with new technologies. Each AFIS has unique value-added features that utilize finger images in different ways. Various mathematical computations and manipulations of the images can provide rich information regarding the nature of the finger image.

The images captured by fingerprint scanner 606 meet all requirements as set forth by Appendix-F of the FBI's IQS certification testing.

The images from fingerprint scanner 606 are compatible with most AFIS software because most AFIS providers have based their image requirements on this FBI standard.

FBI/IAFIS Connectivity

In the United States, the FBI maintains an international AFIS, called IAFIS, designed to help identify transient criminals. Through a Nationwide program, local and State agencies can access the IAFIS through various connection options that depend on throughput (i.e. dial-up, frame relay, ISDN, leased line, etc.).

Additional information on the IAFIS program can be found on the FBI's website at http://www.fbi.gov.

Compatibility with the Mobile Hand-held Scanner Images

The images captured from fingerprint scanner 606 can be completely compatible with the images obtained using a mobile digital finger scanner that captures single plain impressions.

Images from a mobile digital finger scanner can be compared against a local or State database of fingerprint scanner 606 images using an AFIS.

For example, right index finger images captured using a mobile digital finger scanner can be compared to the NCIC2000 National database available through the FBI.

Information regarding NCIC2000 can be found on the FBI's web site at http://www.fbi.gov.

Summary

Fingerprint scanner 606 leads the industry with its lightweight modular design, high quality 500 to 1000 dpi imaging, digital FIREWIRE interface, computer-controlled camera and lighting, real-time numerical feedback and automatic self-calibration. Whether a user's application resides inside a police station, on the back of a truck or in a hut on the border, fingerprint scanner 606 provides reliable consistent finger imaging. Mobile and remote applications unable to be satisfied with previous live scan products now have an opportunity to flourish due to the rugged, lightweight construction of fingerprint scanner 606.

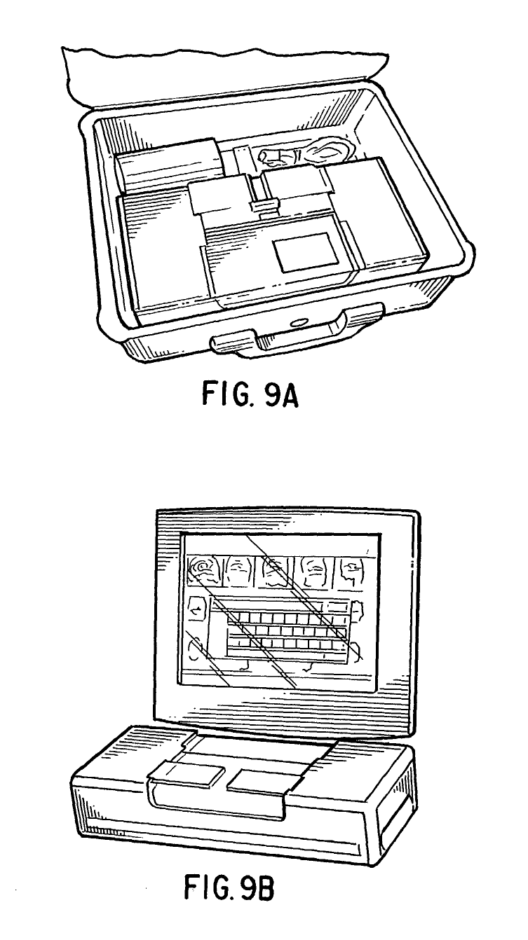

FIG. 9A illustrates the compact size and portability of fingerprint scanner 606 according to an embodiment of the present invention.

FIG. 9B shows an example of a fingerprint imaging system incorporating fingerprint scanner 606, according to an embodiment of the present invention.

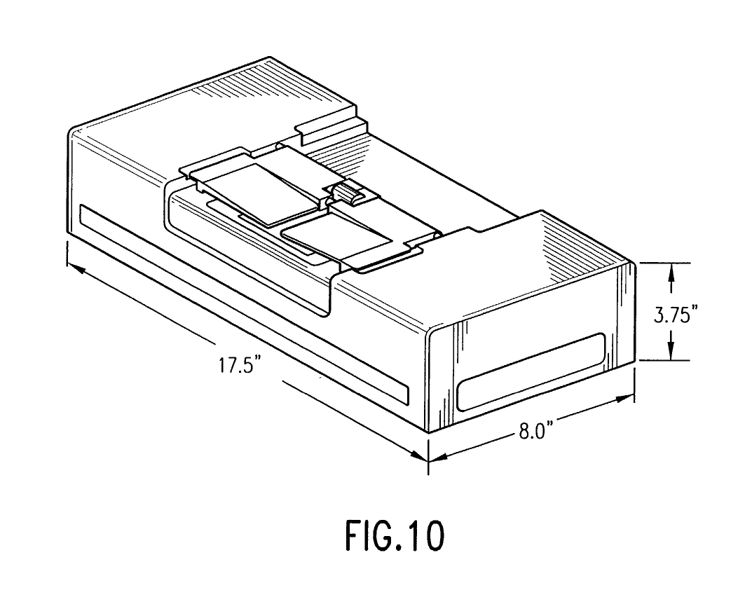

FIG. 10 shows a perspective view of an example fingerprint scanner 606 according to an embodiment of the present invention.

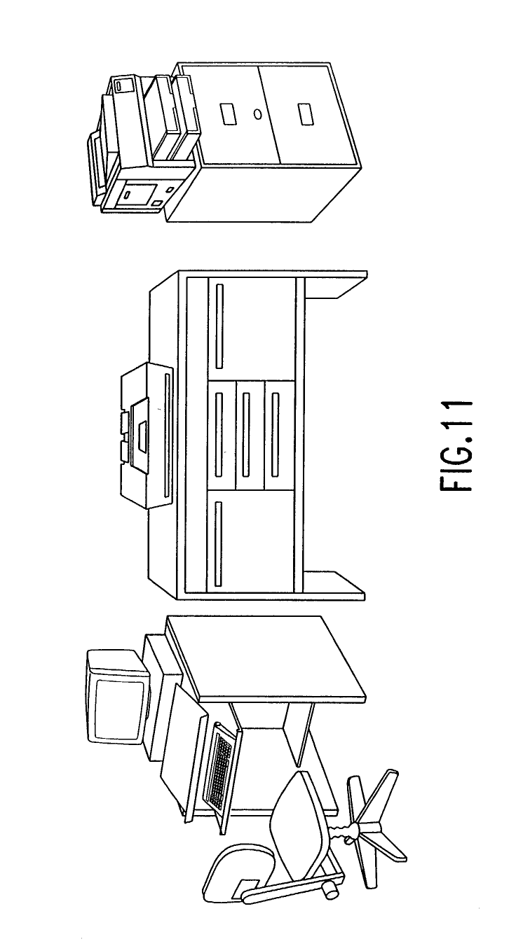

FIG. 11 shows a computer system interfaced with an fingerprint scanner 606 in an example set up according to an embodiment of the present invention.

Through industry partnerships, fingerprint scanner 606 has been tested to comply with AFIS and FBI standards to ensure a successful implementation into any system or project.

With a low initial and life-cycle maintenance cost, fingerprint scanner 606 comes with excellent 2^{nd} level product support for VARs, System Integrators and Distributors worldwide.

Features and Benefits

Table 3 provides further description of at least some of the features and benefits of fingerprint scanner 606 fingerprint scanner.

TABLE 3

| Features | Benefits | Reason Benefit Exists |
|---|---|---|
| 1. RUG- | Protects the internal electro- | Fingerprint scanner |
| GED, | optical components in harsh | 606 has an all-alumi- |
| LIGHT- | environments while maintaining | num housing with |
| WEIGHT | a weight suitable for | built-in handles and a |
| | mobile/portable applications, as | weight of 23 pounds. |
| | well as overnight shipping. | suitable for mobile/ |
| | | portable applications, |
| | | as well as overnight |
| | | shipping. |
| 2. MOV- | Reduces hardware cost & | Because a small area |
| ING | incorporates a unique, faster | of the platen is imaged |
| PLATEN | method of rolled image capture. | at any given time, a |
| SUR- | | more affordable linear- |
| FACE | | type camera/sensor is |
| | | used. Plus, because the |
| | | frames of the image |
| | | are stitched together in |
| | | software, it means you |
| | | can stop, back up, and |
| | | keep rolling. This |
| | | reduces the need for |
| | | retaking the entire |
| | | image, which saves |
| | | time. |
| 3. AUTO- | Fingerprint scanner 606 can be | The platen is auto- |
| MATIC | calibrated before each use or at | matically placed in a |
| SELF- | the start of each day (or at some | specific target-viewing |
| | routine interval), to ensure | position. In software, |
| | optimum image quality. This is | the images of the |
| | done through a simple automated | targets are analyzed |
| | process; there is no need for a | and then appropriate |
| | technician or engineer to visit | adjustments to the |
| | on-site. | electro-optical system |
| | | are made for ultimate |
| | | imaging. |
| 4. DIGI- | Digital imaging directly from the | Fingerprint scanner |
| TAL | camera to the computer means | 606 has an on-board |
| FIREWIRE | the system is completely digital | 400 Mbps FIREWIRE |
| INTER- | (no analog video signals or A-to- | (IEEE 1394) chipset |
| FACE | D converters). Also, the device is | that can handle |
| | plug-and-play. . . very easy to | multiple, high speed |
| | install and set-up. | live video (imaging) |
| | | channels; as well as |
| | | any additional audio |
| | | and data communi- |
| | | cations. |
| 5. COM- | Increased control (either | The illumination and |
| PUTER | automatic or manual) of the | camera system (includ- |
| CON- | quality of images means it is | ing the LED's) is fully |
| TROLLED | easier to accommodate different | adjustable through a |
| CAMERA & | fingerprint conditions, such as | software development |
| LIGHTING | wetness or dryness. | interface that can be |
| | | programmed to auto- |
| | | matically respond to |
| | | variations experienced |
| | | from the live images. |
| 6. NUMER- | This gives system developers | Through software, the |
| ICAL | more control over the operation | developer is given |
| FEEDBACK | of fingerprint scanner 606 and | access to real-time |
| | how it interacts with the rest of | numerical data from |
| | the system. | fingerprint scanner |
| | | 606. |
| 7. FBI IQS | This ensures interoperability for | Fingerprint scanner |
| APPENDIX- | different AFIS systems and | 606 has passed all of |
| F | certifies the image quality meets | the image quality tests |
| CERTI- | the most stringent industry | required by the FBI at |
| FIED* | standards. | the Appendix F level.* |
| 8. 1000 DPI | The higher quality images | All fingerprint scanner |
| RESOLU- | produced by fingerprint scanner | 606 units are capable |
| TION | 606 results in a more accurate | of image resolutions |
| | match/no-match decision by an | well over 1000 dpi. |
| | AFIS or through manual | A future, optional |
| | methods. | software/firmware |
| | | upgrade will be avail- |
| | | able which can be |
| | | installed to allow both |
| | | 500 and 1000 dpi |
| | | imaging. |
| 9. MODU- | This allows customers to take | Fingerprint scanner |
| LAR | advantage of future product | 606 has several rear |
| DESIGN | hardware improvements, | access panels where |
| | enhancements and add-ons. | the electronics reside. |
| | | Future board replace- |
| | | ments with added |
| | | features could be |
| | | installed via these |
| | | access panels. |
| 10. COST | The low price of fingerprint | The price for finger- |
| EFFECTIVE | scanner 606 means the overall | print scanner 606 is |
| | price of the system solution is | 20-30% less than most |
| | lower; a competitive advantage | fingerprint live |
| | in the bid process. | scanners offered by the |
| | | competition. |

Mechanical Specifications

Table 4 provides mechanical specifications for an example fingerprint scanner 606 fingerprint scanner according to embodiment of the present invention.

TABLE 4

| | 500 dpi ± 3 pixels in X and Y axis, Upgradeable to |
|---|---|
| Resolution | 1000 dpi |
| Modulation Transfer | 50% at 5 cycles per millimeter on finger platen |
| Function | |
| Linearity and Rectil- | ±3 Pixels |
| inearity | |
| Image Area/Platen | 1.5″ × 1.6″ (38 mm × 41 mm) in Roll Mode |
| Size | 2″ × 3.2″ (51 mm × 81 mm) in Slap Mode |
| Output | FIREWIRE (IEEE 1394) Female |
| Power | 12 V DC @ 3 A |
| Temperature Range | 35° F. to 100° F. (2° C. to 38° C.) |
| Humidity Range | 90% non-condensing; splash resistant |
| Weight | 23.0 lbs (10.4 kg) |
| Dimensions (H × | 3.75″ × 8.0″ × 17.5″ (92 mm × 203 mm × 429 |
| L × W) | mm) |

Computer System

Table 5 provides computer system requirements of an example fingerprint scanner 606 according to an embodiment of the present invention. Higher or lower requirements can be used in different examples of the invention.

TABLE 5

| | |
|---|---|
| Processor | Pentium II 400 MHz or greater |
| Internal Bus | 100 MHz or greater |
| Memory | 64 MB minimum (>128 MB |
| | recommended) |
| Operating System | Windows NT 4.0 SPR 5 or Windows |
| | 2000 |
| Hard Drive | 6 GB EIDE minimum (>13 GB SCSI |
| | recommended) |
| FIREWIRE Interface Adapter | IEEE 1394 Compliant |
| Monitor | 17″ SVGA minimum (21″ Touch LCD |
| | recommended) |
| Surge Protect/UPS | 600 VA or better UPS with Surge |
| | Protection |

Example GUI Computer Environment

FIG. 12 is a block diagram illustrating an example environment in which the present invention can operate. The environment is a computer system 1200 that includes one or more processors, such as processor 1204. The processor 1204 is connected to a communications bus 1202. Various software embodiments are described in terms of this example computer system. After reading this description, it will be apparent to a person skilled in the relevant art how to implement the invention using other computer systems and/or computer architectures.

Computer system 1200 includes a graphics subsystem 1203. Graphics subsystem 1203 can be implemented as one or more processor chips. The graphics subsystem 1203 can be included as part of processor 1204 as shown in FIG. 24 or as a separate graphics engine or processor. Graphics data is output from the graphics subsystem 1203 to the bus 1202. Display interface 1205 forwards graphics data from the bus 1202 for display on the display unit 1206. This graphics data includes graphics data for the screen displays described herein.

Computer system 1200 also includes a main memory 1208, preferably random access memory (RAM), and can also include a secondary memory 1210. The secondary memory 1210 can include, for example, a hard disk drive 1212 and/or a removable storage drive 1214, representing a floppy disk drive, a magnetic tape drive, an optical disk drive, etc. The removable storage drive 1214 reads from and/or writes to a removable storage unit 1218 in a well known manner. Removable storage unit 1218 represents a floppy disk, magnetic tape, optical disk, etc., which is read by and written to by removable storage drive 1214. As will be appreciated, the removable storage unit 1218 includes a computer usable storage medium having stored therein computer software and/or data.

In alternative embodiments, secondary memory 1210 may include other similar means for allowing computer programs or other instructions to be loaded into computer system 1200. Such means can include, for example, a removable storage unit 1222 and an interface 1220. Examples can include a program cartridge and cartridge interface (such as that found in video game devices), a removable memory chip (such as an EPROM, or PROM) and associated socket, and other removable storage units 1222 and interfaces 1220 which allow software and data to be transferred from the removable storage unit 1222 to computer system 1200.

Computer system 1200 may also include a communications interface 1224. Communications interface 1224 allows software and data to be transferred between computer system 1200 and external devices via communications path 1226. Examples of communications interface 1224 can include a modem, a network interface (such as an Ethernet card), a communications port, etc. Software and data transferred via communications interface 1224 are in the form of signals which can be electronic, electromagnetic, optical or other signals capable of being received by communications interface 1224, via communications path 1226. Note that communications interface 1224 provides a means by which computer system 1200 can interface to a network such as the Internet.

In the present invention, communications interface 1224 may include a FIREWIRE (or IEEE 1394) port and PCI adapter as a mode of communication between computer system 1200 and the fingerprint scanner 106. In embodiments, video and data communications may be transferred simultaneously across this connection.

Graphical user interface module 1230 transfers user inputs from peripheral devices 1232 to bus 1206. These peripheral devices 1232 can be a mouse, keyboard, touch screen, microphone, joystick, stylus, light pen, or any other type of peripheral unit. These peripheral devices 1232 enable a user to operate and control the data visualization tool of the present invention as described herein.

The present invention is described in terms of this example environment. Description in these terms is provided for convenience only. It is not intended that the invention be limited to application in this example environment. In fact, after reading the following description, it will become apparent to a person skilled in the relevant art how to implement the invention in alternative environments.

The present invention is preferably implemented using software running (that is, executing) in an environment similar to that described below with respect to FIG. 11. In this document, the term “computer program product” is used to generally refer to removable storage device 1218 or a hard disk installed in hard disk drive 1212. These computer program products are means for providing software to computer system 1200.

Computer programs (also called computer control logic) are stored in main memory and/or secondary memory 1210. Computer programs can also be received via communications interface 1224. Such computer programs, when executed, enable the computer system 1200 to perform the features of the present invention as discussed herein. In particular, the computer programs, when executed, enable the processor 1204 to perform the, features of the present invention. Accordingly, such computer programs represent controllers of the computer system 1200.

In an embodiment where the invention is implemented using software, the software may be stored in a computer program product and loaded into computer system 1200 using removable storage drive 1214, hard drive 1212, or communications interface 1224. Alternatively, the computer program product may be downloaded to computer system 1200 over communications path 1226. The control logic (software), when executed by the processor 1204, causes the processor 1204 to perform the functions of the invention as described herein.

In another embodiment, the invention is implemented primarily in firmware and/or hardware using, for example, hardware components such as application specific integrated circuits (ASICs). Implementation of a hardware state machine so as to perform the functions described herein will be apparent to persons skilled in the relevant art(s).

Conclusion

While various embodiments of the present invention have been described above, it should be understood that they have been presented by way of example only, and not limitation. It will be apparent to persons skilled in the relevant art that various changes in form and detail can be made therein without departing from the spirit and scope of the invention. Thus, the breadth and scope of the present invention should not be limited by any of the above-described exemplary embodiments, but should be defined only in accordance with the following claims and their equivalents.

What is claimed is:

1. A method for interfacing between a graphical user interface and a fingerprint scanner, comprising the steps of:
(a) receiving a parameter from the graphical user interface; and
(b) sending the parameter to a fingerprint scanner.

2. The method of claim 1, wherein the parameter is a status parameter, further comprising the steps of:
(c) receiving a status response from the fingerprint scanner; and
(d) returning the status response to the graphical user interface.

3. The method of claim 2, wherein the status parameter is a brightness, contrast, live mode, image format, integration time, crop mode, zoom mode, zoom factor, zoom left, zoom top, correction mode, get line, motor position, limit speed, motor status, or motor mode status request.

4. The method of claim 1, wherein the parameter is a control parameter, and wherein step (a) comprises receiving a control parameter from the graphical user interface.

5. The method of claim 4, wherein the control parameter is a parameter corresponding to any one of the following requests: brightness, contrast, live mode, image format, integration time, crop mode, zoom mode, zoom factor, zoom left, zoom top, correction mode, get line, motor position, limit speed, motor status, motor mode, calibration, or LED/lighting control request.

6. The method of claim 2, further comprising the step of:
(e) determining whether the parameter is a status parameter or a control parameter.

7. The method of claim 1, wherein the fingerprint scanner is a ten-print fingerprint scanner, and wherein step (b) comprises the step of sending the parameter the ten-print fingerprint scanner.

8. The method of claim 1, wherein the graphical user interface is supported by a personal computer, and wherein step (a) comprises the step of receiving a parameter from the graphical user interface through the personal computer.

9. An interface between a fingerprint scanner and a graphical user interface, comprising:
a software development kit coupling the fingerprint scanner with the graphical user interface, said software development kit comprising:
an image capture module,
an image format module,
an image enhancement module,
a motor control module,
a calibration control module, and
a LED/lighting control module.

10. The interface of claim 9, wherein the fingerprint scanner is a ten-print fingerprint scanner.

11. The interface of claim 9, wherein a computer system comprises the graphical user interface and said software development kit.

12. The interface of claim 9, wherein said image capture module receives a control or status request from the graphical user interface, sends said control or status request to the fingerprint scanner, receives a status response from the fingerprint scanner, and returns said status response to the graphical user interface, wherein said control or status request is a brightness, contrast, or live mode request.

13. The interface of claim 9, wherein said image format module receives a control or status request from the graphical user interface, sends said control or status request to the fingerprint scanner, receives a status response from the fingerprint scanner, and returns said status response to the graphical user interface, wherein said control or status request is a image format, integration time, crop mode, zoom factor, or zoom left, zoom top request.

14. The interface of claim 9, wherein said image enhancement module receives a control or status request from the graphical user interface, sends said control or status request to the fingerprint scanner, receives a status response from the fingerprint scanner, and returns said status response to the graphical user interface, wherein said control or status request is a correction mode, or get line request.

15. The interface of claim 9, wherein said motor control module receives a control or status request from the graphical user interface, sends said control or status request to the fingerprint scanner, receives a status response from the fingerprint scanner, and returns said status response to the graphical user interface, wherein said control or status request is a motor position, limit speed, motor status, or motor mode request.

16. The interface of claim 9, wherein said calibration control module receives a control request from the graphical user interface, and sends said control request to the fingerprint scanner, wherein said control request is a calibration request.

17. The interface of claim 9, wherein said LED/lighting control module receives a control request from the graphical user interface, and sends said control request to the fingerprint scanner.

18. A software development kit between a fingerprint scanner and a graphical user interface, comprising:
a software development kit coupling the fingerprint scanner with the graphical user interface, said software development kit comprising at least one of:
an image capture module,
an image format module,
an image enhancement module,
a motor control module,
a calibration control module, and
a LED/lighting control module.

19. A computer program product comprising a computer useable medium having computer program logic recorded thereon for enabling a processor in a computer system to interface a fingerprint scanner and a graphical user interface, comprising:
a software development kit coupling the fingerprint scanner with the graphical user interface, said software development kit comprising at least one of:
an image capture module,
an image format module,
an image enhancement module,
a motor control module,
a calibration control module, and
a LED/lighting control module.
